(19) United States
(12) Patent Application Publication
(10) Pub. No.: US 2026/0041282 A1
(43) Pub. Date: Feb. 12, 2026

(54) STAND MIXER APPLIANCE FOOD MILL ATTACHMENT

(71) Applicant: Haier US Appliance Solutions, Inc., Wilmington, DE (US)

(72) Inventors: Emily Rose Ashburn, Louisville, KY (US); Tomas Garces, Louisville, KY (US); Rocco J. Cordaro, Louisville, KY (US)

(21) Appl. No.: 18/800,582

(22) Filed: Aug. 12, 2024

(51) Int. Cl. A47J 43/044; A47J 43/07; A47J 43/25

(52) U.S. Cl. CPC A47J 43/044; A47J 43/0727; A47J 43/255; A47J 2043/0449

(57) ABSTRACT

A stand mixer includes a housing with a motor disposed in the housing. A mixing shaft is operably coupled to the motor. A mixing bowl is positioned beneath the mixing shaft, and a food mill attachment is coupled to the bowl. The food mill attachment is mechanically coupled to the mixing shaft. The food mill attachment includes a transmission mechanically coupling a disk to the motor along a central axis. The disk is rotatable around the central axis in both a clockwise direction and a counterclockwise direction. The food mill attachment also includes a food mill bowl coupled to the mixing bowl. The food mill bowl receives food items for processing.

### FIELD OF THE INVENTION

The present subject matter relates generally to stand mixer appliances, and specifically to systems for mashing food items with the stand mixer appliance.

### BACKGROUND OF THE INVENTION

Stand mixers are generally used for performing mixing, churning, or kneading involved in food preparation. Typically, stand mixers include a motor configured to provide torque to one or more driveshafts. Users may connect various utensils to the one or more driveshafts, including whisks, spatulas, or the like. When performing food preparation on potatoes, which have a large amount of starch, the cells that contain the starch burst and release a tacky gel that binds into mashed potatoes. When overcooking or over mashing the potatoes, the tacky gel may result in very gummy, sticky mashed potatoes due to too much starch bursting from the cells.

Traditionally, chefs and/or professional cooks prefer using manual methods along with separate appliances such as a ricer or a food mill to achieve smooth and fluffy mashed potatoes. In some cooking operations, other foods, such as strawberries and apples may be strained or pureed, respectively. However, for the typical user, to achieve smooth and fluffy mashed potatoes, straining seeds from berries, and/or pureeing apples to make applesauce, handheld manual tools may be used. The use of handheld tools is typically a manually intensive process and is undesirable to users due to it being manually intensive.

Accordingly, a stand mixer with an attachment for automatically performing food processing operations, such as those mentioned above, would be advantageous in the art.

### BRIEF DESCRIPTION OF THE INVENTION

Aspects and advantages of the invention will be set forth in part in the following description, or may be apparent from the description, or may be learned through practice of the invention.

In one example embodiment, a stand mixer is provided. The stand mixer defines a vertical direction, a lateral direction, and a transverse direction. The vertical, lateral, and transverse directions are mutually perpendicular. The stand mixer includes a housing with a motor disposed in the housing. A controller is in operable communication with the motor. A mixing shaft is operably coupled to the motor. A mixing bowl positioned beneath the mixing shaft, and a food mill attachment is coupled to the bowl. The food mill attachment is mechanically coupled to the mixing shaft. The food mill attachment includes a transmission mechanically coupling a disk to the motor along a central axis. The disk is rotatable around the central axis in both a clockwise direction and a counterclockwise direction. The food mill attachment also includes a food mill bowl coupled to the mixing bowl. The disk is positioned and configured to rotate within the food mill bowl. The food mill bowl receives food items for processing. The food mill bowl defines a plurality of apertures through a bottom side of the food mill bowl.

In another example embodiment, a stand mixer is provided. The stand mixer includes a housing with a motor disposed in the housing. A mixing shaft is operably coupled to the motor. A mixing bowl positioned beneath the mixing shaft, and a food mill attachment is coupled to the bowl. The food mill attachment is mechanically coupled to the mixing shaft. The food mill attachment includes a transmission mechanically coupling a disk to the motor along a central axis. The disk is rotatable around the central axis in both a clockwise direction and a counterclockwise direction. The food mill attachment also includes a food mill bowl coupled to the mixing bowl. The food mill bowl receives food items for processing.

In another example embodiment, a food mill attachment for a stand mixer is provided. The food mill attachment includes a transmission mechanically coupling a disk to the stand mixer. The disk is rotatable around a central axis in both a clockwise direction and a counterclockwise direction. The food mill attachment also includes a food mill bowl receives food items for processing. The food mill bowl defines a plurality of apertures through a bottom side of the food mill bowl. The disk is positioned within the food mill bowl and configured to rotate within the food mill bowl.

These and other features, aspects and advantages of the present invention will become better understood with reference to the following description and appended claims.

The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of an example stand mixer with a bowl according to example embodiments of the present disclosure.

FIG. 2 provides a side view of the stand mixer with a mixing attachment according to example embodiments of the present disclosure.

FIG. 3 illustrates a perspective view of an example embodiment of a stand mixer appliance with a food mill attachment, according to aspects of the present disclosure.

FIG. 4 illustrates a perspective view of an example food mill bowl of the food mill attachment of FIG. 3, according to aspects of the present disclosure.

FIG. 5 illustrates a perspective view of an example orbital and orbital adapter of the food mill attachment of FIG. 3, according to aspects of the present disclosure.

FIG. 6 illustrates a perspective view of an example transfer block and receiver block of the food mill attachment of FIG. 3, according to aspects of the present disclosure.

FIG. 7 illustrates a perspective view of example components of the food mill attachment of FIG. 3, according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising. ” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

The terms “coupled,” “fixed,” “attached to,” and the like refer to both direct coupling, fixing, or attaching, as well as indirect coupling, fixing, or attaching through one or more intermediate components or features, unless otherwise specified herein.

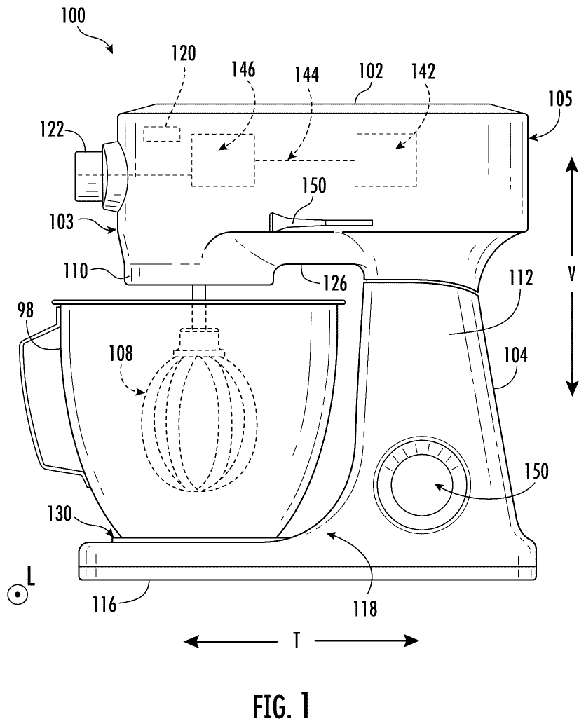

The present disclosure provides a mixer appliance with a secure mixing attachment coupling to a mixing shaft of the mixer appliance. This secure coupling may allow the mixer to rotate the shaft with the secured mixing attachment in clockwise and counterclockwise motions. The figures depict an example stand mixer appliance 100 that may be configured in accordance with various aspects of the present disclosure. It should be appreciated that the invention is not limited to any particular style, size, model, or shape for stand mixer appliance 100. The example embodiment in FIG. 1 is for illustrative purposes only. For example, appliance 100 may have different shapes and appearance for one or more parts, different motor and gear configurations, and other differences while remaining within the scope of the claimed subject matter.

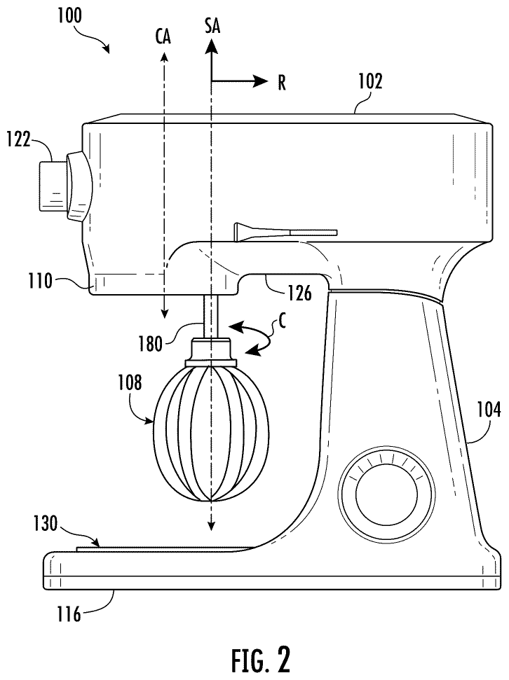

With reference for FIGS. 1 and 2, for the particular embodiment shown, a stand mixer appliance 100 includes a housing 102 and a base 104. Stand mixer 100 may extend between housing 102 and base 104 in a vertical direction V, across housing 102 in a lateral direction L, and from a front 103 to a back 105 in a transverse direction T. The vertical direction V, lateral direction L, and transverse direction T are perpendicular to one another.

Housing 102 may be pivotally mounted to base 104 and extends transversely between front 103 and back 105 of stand mixer appliance 100 when in the mixing position shown in FIG. 1. In some embodiments, housing 102 may be non-pivotably attached to base 104. Other configurations may be used where housing 102 may allow for access to a mixing bowl 98 or to a removable mixing attachment 108, as otherwise understood. For this embodiment, base 104 includes upright support 112 and a horizontal base member 116. As shown, upright support 112 extends vertically from horizontal base member 116 and horizontal base member 116 extends transversely in front of upright support 112. Horizontal base member 116 may include a scale 130. In some embodiments, scale 130 may be concave, grooved, or otherwise shaped to accept mixing bowl 98. Scale 130 may be generally configured to weigh mixing bowl 98 and the contents therein.

Housing 102 includes an attachment support 110. A motor 142 is disposed within the housing 102. Attachment support 110 is located on a lower portion or underside 126 of housing 102 and forward of upright support 112 along transverse direction T. A mixing shaft 180 extends from attachment support 110. Removable mixing attachment 108 removably attaches to shaft 180.

Drivetrain 144 connects motor 142 with one or more gears 146 for causing rotation of attachment 108 or mixing shaft 180, e.g., mixing shaft 180 may be operably coupled to motor 142. Gears 146 may allow for selection by the user of different rotating speeds for attachment 108. In general, mixing attachment 108 may be coupled to shaft 180 prior to rotation of shaft 180 by motor 142. Furthermore, a power take off 122 may be positioned at housing 102, e.g., power take off 122 may extend from front 103 of housing 102. In general, power take off 122 may be mechanically coupled to drivetrain 144, ergo motor 142.

Stand mixer 100 may include one or more controls 150 for operations such as selectively powering motor 142, choosing the speed of rotation for attachments 108, locking position of housing 102 relative to base 104 during mixing, or other features. In some embodiments, controls 150 may include a rotational direction operation selection, allowing a user to select the direction of rotation of the mixing shaft 180.

In certain embodiments, attachment support 110 may accept more than one attachment 108. Various types of attachments 108 may be used including e.g., whisks, paddles, dough hooks, beaters, and others for purposes of mixing articles or mechanically manipulating articles within mixing bowl 98 or other containers supported by base 104.

During use, attachment support 110 with mixing shaft 180 may rotate attachment 108 in a circular or planetary fashion. Spinning in a planetary fashion, as used herein, includes spinning an object (e.g., shaft 180) about a first axis and revolving the object around a second axis, the object offset from the second axis. For example, shaft 180 may spin about a shaft axis SA, and revolve around a central axis CA, shaft 180 offset from central axis CA to generate spinning in a planetary rotation. Shaft axis SA may also be offset from central axis CA. In some embodiments, motor 142 may be disposed within base 104, including within upright support 112.

As shown in FIG. 2, mixing shaft 180 may rotate within attachment support 110. Mixing attachment 108 and mixing shaft 180 are rotatable by motor 142 in planetary rotation. Mixing shaft may define the shaft axis SA, with a radial direction R extending therefrom perpendicular to the shaft axis SA, and a circumferential direction C extending around the central axis CA. Mixing shaft 180 may rotate around central axis CA, wherein mixing shaft 180 is rotating in circumferential direction C. Additionally or alternatively, motor 142 may be operable to selectively rotate mixing attachment 108 in a clockwise direction or a counterclockwise direction in circumferential direction C around shaft axis SA. Thus, mixing shaft 180 may be reversible, or moveable in either direction during use. Attachment of mixing attachment 108 to shaft 180 allows for motion in both directions, clockwise and counterclockwise, by motor 142. In other words, motor 142 can rotate mixing attachment 108 and/or shaft 180 in a clockwise direction and can switch and rotate mixing attachment 108 and/or shaft 180 in a counterclockwise direction. Such movement may be directed by a user (e.g., by use of controls 150) or may be directed independent of a user, e.g., by using a timer, by using a controller, described hereinbelow, in operable communication with motor 142, or as otherwise understood.

In general, stand mixer 100 may include a controller 120. In particular, controller 120 may be located within housing 102. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 142). For instance, controller 120 may include a printed circuit board (PCB) with various components coupled thereto, as would be understood by those of ordinary skill in the art.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation.

Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, controls 150 may include one or more microprocessors and/or one or more memory devices. Accordingly, certain components of stand mixer 100 may be controlled directly from controls 150. For example, controller 120 may be generally configured to perform a mixing cycle, whereby stand mixer 100 may be operated to mix food contents, such as food contents in mixing bowl 98.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

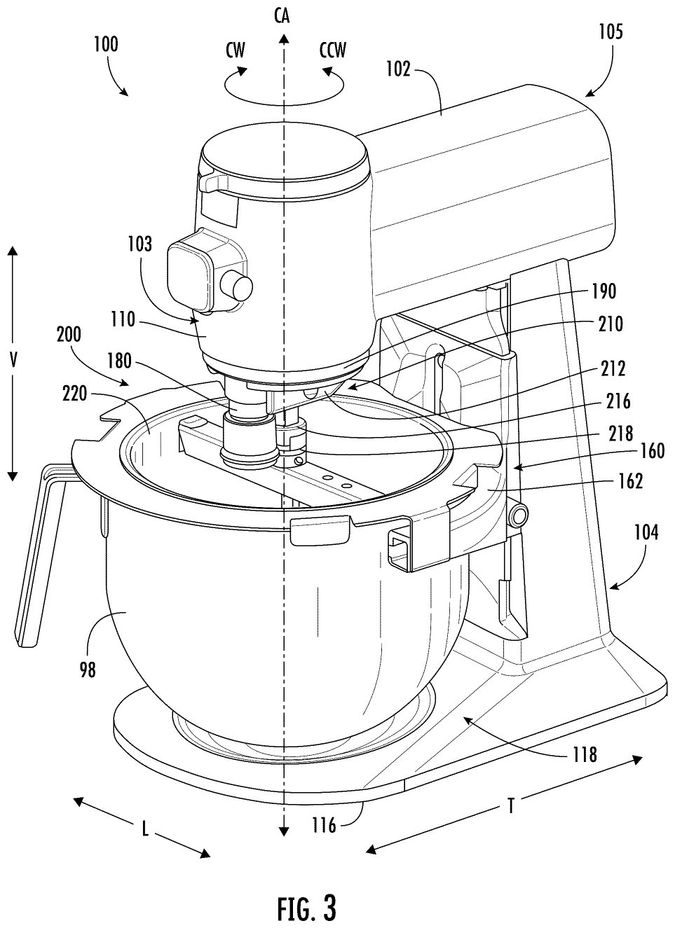

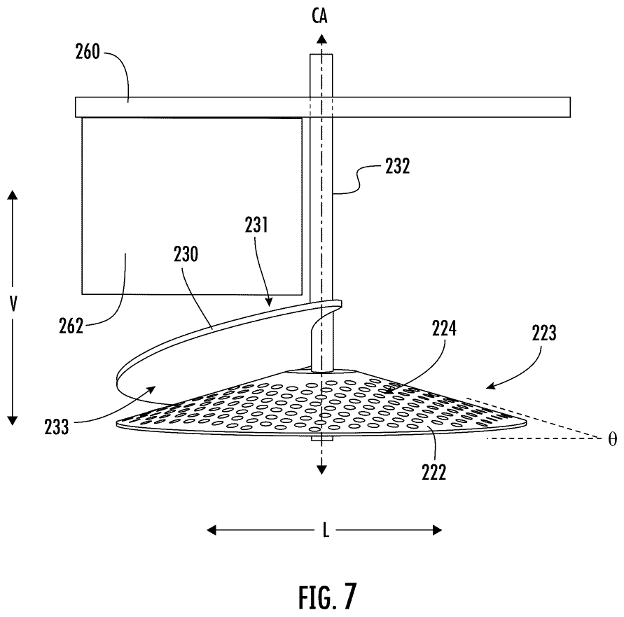

Turning now to FIG. 3, illustrated is a perspective view of an example embodiment of a stand mixer appliance with a food mill attachment. In general, illustrated is a food mill attachment 200 coupled to mixing bowl 98 of stand mixer appliance 100. In general, food mill attachment 200 may also be mechanically coupled to mixing shaft 180 of stand mixer appliance 100. In general, food mill attachment 200 may include a transmission 210 and a food mill bowl 220. As illustrated in FIG. 3, stand mixer 100 may include an orbital 190 coupled to housing 102 over mixing shaft 180. In general, orbital 190 may be a curved plate covering part of attachment support 110. Transmission 210 may generally mechanically couple a disk 230 (FIG. 7) to motor 142, such as by orbital 190, along central axis CA, as will be explained herein. A food mill bowl may be coupled to mixing bowl 98.

Disk 230 may be positioned within the food mill bowl 220 and configured to rotate within food mill bowl 220. Disk 230 will be described in further detail herein. In general, food mill bowl 220 may be configured for receiving food items for processing. In particular, food mill bowl 220 may define a plurality of apertures 224 (FIG. 7) through a bottom side 222 (FIG. 7) of food mill bowl 220, whereby food items may be forced through the plurality of apertures 224 to mash, strain, puree, etc., as will be explained further herein.

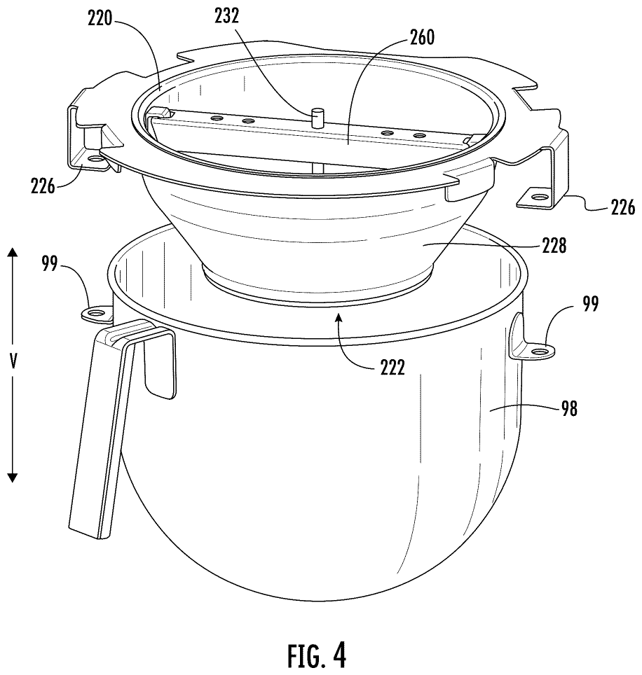

As may be seen throughout FIG. 3, stand mixer 100 may include a bowl lift framework 160. The bowl lift framework 160 may hold mixing bowl 98 via spikes (not shown) on arms 162, which may removably couple to flanges 99 (FIG. 4) extending from bowl 98. For instance, each mounting spike on arms 162 may be received within a respective flange 99 on mixing bowl 98. Mixing bowl 98 may generally be positioned between arms 162, e.g., along the lateral direction L. Thus, arms 162 may be positioned on respective sides of mixing bowl 98.

Illustrated in FIG. 4 is a perspective view of an example food mill bowl 220 of the food mill attachment 200. In general, food mill bowl 220 may generally be defined by bottom side 222 and curved sidewall 228. Extending from food mill bowl, such as from a top edge of sidewall 228, may be a pair of support arms 226. In general, support arms 226 may hold food mill bowl 220 over mixing bowl 98 via spikes (not shown) on arms 162 of bowl lift framework 160, e.g., support arms 226 may hold food mill bowl 220 such that bottom side 222 of food mill bowl 220 is received within mixing bowl 98. For example, the mounting spikes on arms 162 may removably couple through flanges 99 of mixing bowl 98 and into support arms 226 of food mill bowl 220. For instance, each mounting spike on arms 162 may be received within a respective flange 99 on mixing bowl 98 and within a respective support arm 226 of food mill bowl 220.

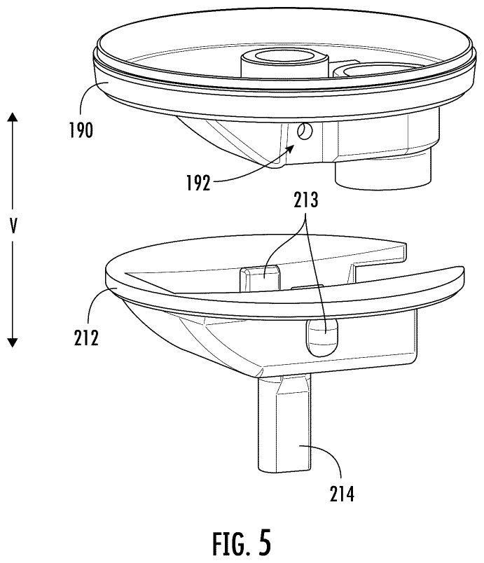

FIG. 5 illustrates a perspective view of an example orbital 190 of stand mixer 100 and an orbital adapter of the food mill attachment 200. In general, transmission 210 of food mill attachment 200 may include an orbital adapter 212 configured to removably couple to the orbital 190 of stand mixer appliance 100. In particular, some example embodiments of orbital adapter 212 include a biasing member 213. In general, biasing member 213 may be a spring and/or pin positioned through orbital adapter 212. In some example embodiments, biasing member 213 may include buttons on an exterior of orbital adapter 212, wherein a user may push the buttons to disengage biasing member 213 from orbital 190 and remove orbital adapter 212 from orbital 190. In particular, biasing member 213 may be configured to secure/couple orbital adapter 212 to orbital 190. For example, orbital 190 may include detents 192 which may receive biasing member 213 of orbital adapter 212. In general, orbital adapter 212 may include a central shaft 214 extending downward, in the vertical direction V, such as along central axis CA of stand mixer appliance 100. In general, central shaft 214 may transmit rotational motion to disk 230, as will be described herein.

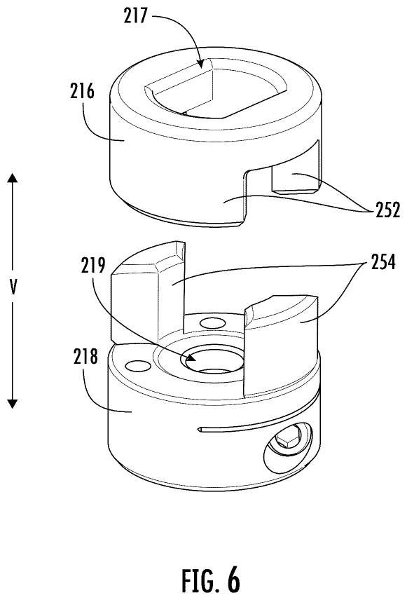

Illustrated in FIG. 6 is a perspective view of an example transfer block and receiver block of the food mill attachment 200. In general, transmission 210 may include a transfer block 216 and a receiver block 218. In particular, transfer block 216 may couple to central shaft 214 of orbital adapter 212, e.g., transfer block 216 may include an opening 217 configured to receive central shaft 214. In some example embodiments, the shaft 214 and the opening 217 may include matching shapes, such that opening 217 may be sized such that shaft 214 may fit therein and engage with transfer block 216. In particular, shaft 214 and opening 217 may include flat sides configured to fit together, such that shaft 214 does not spin within opening 217 and rather engages with and rotates transfer block 216. As such, transfer block 216 and orbital adapter 212 may be locked together to prevent/reduce or limit relative rotation therebetween. Further, receiver block 218 may couple to a shaft 232 (FIG. 7) extending from disk 230, e.g., receiver block 218 may include opening 219 configured to receive shaft 232. Shaft 232 may be seen illustrated in FIGS. 4 and 7, extending in the vertical direction V from within food mill bowl 220.

In general, transfer block 216 may transfer torque, e.g., rotational motion, from central shaft 214 to receiver block 218, thus rotating shaft 232, and thereby rotating disk 230. Specifically, in the present example embodiment, rotation of central shaft 214 is imparted to transfer block 216 by the engagement of shaft 214 within opening 217, and then rotation of transfer block 216 is imparted to receiver block 218 via the interlocking engagement of prongs 252, 254. In particular, transfer block 216 may include a pair of transfer prongs 252 configured to interlock with a pair of receiver prongs 254 extending from receiver block 218. While illustrated as a pair of transfer prongs 252 and a pair of receiver prongs 254, one of skill in the art would understand that any number of prongs, such as one (1) prong, or such as three (3) or more prongs may be used. Additionally, in other example embodiments, transfer block 216 and receiver block 218 may be combined into one block with respective openings 217 and 219 at each respective end.

Turning now to FIG. 7, illustrated is a perspective view of example components of the food mill attachment 200. In general, disk 230 may be a semi-circular, disk-like blade wrapping around shaft 232, and positioned within food mill bowl 220. In some example embodiments, disk 230 may be rotatable in both directions around central axis CA, such as the clockwise (CW) direction and the counterclockwise (CCW) direction around central axis CA. In general, disk 230 may be defined between a top side 231 and a bottom side 233, as well as may wrap around shaft 232 in the vertical direction V, such that disk 230 is angled, as will be described below. Additionally, bottom side 222 of food mill bowl 220 may include a conical shape 223 at an angle, such as angle θ. In general, disk 230 may extend around shaft 232 at an angle commensurate to bottom side 222, or, vice versa, bottom side 222 may be at an angle commensurate to disk 230, e.g., similar or the same as angle θ. As such, bottom side 233 of blade 230 may be in contact with bottom side 222 of food mill bowl 220 across a width of disk 230 as disk 230 rotates around central axis CA. For example, angle θ of blade 230 and bottom side 222 of food mill bowl 220, from a plane defined by the lateral direction L and the transverse direction T, may be between one degree (1°) and sixty degrees (60°), such as between five degrees (5°) and forty degrees (40°), such as between ten degrees (10°) and twenty degrees (20°).

In some example embodiments, food mill bowl 220 may include a scrape plate 262 positioned proximate top side 231 of disk 230. In general, scrape plate 262 may scrape food items from top side 231 of disk 230 when disk 230 is rotated in one of the directions around central axis CA. For example, rotating disk 230 in the clockwise direction may scrape food items from atop bottom side 222 of food mill bowl 220, and scrape plate 262 may scrape food items from top side 231 of disk 230. In general, in some example embodiments, scrape plate 262 may extend from the interior of sidewall 228 of food mill bowl 220. Other example embodiments, such as those illustrated in FIGS. 3, 4, and 7, may include a support bar 260 extending within food mill bowl 220, whereby scrape plate 262 may extend from support bar 260.

As stated above, bottom side 222 of food mill bowl 220 may define a plurality of apertures 224 through which food items may be forced to mash, strain, puree, etc., food items. In particular, as illustrated in FIG. 7, rotating disk 230 in the counterclockwise direction may squeeze food between bottom side 233 of disk 230 and the plurality of apertures 224 of bottom side 222 of food mill bowl 220. As such, depending on rotation speed and torque of disk 230, food items may be mashed, strained, pureed, etc., through food mill bowl 220.

In general, controller 120 may generally measure torque of motor 142 while motor 142 is mixing food contents. For example, torque may be directly influenced by the state, e.g., viscosity of the mixture, and/or presence of the food contents. In particular, controller 120 measuring torque of motor 142 may include controller 120 monitoring both of current draw (Amperes) and motor speed (revolutions per minute) of motor 142 in order to calculate torque of motor 142.

In some example embodiments, controller 120 may be further configured to record a baseline torque value for comparison with measurements while motor 142 operates to mix food contents. In some example embodiments, the baseline torque value may indicate a minimum torque value when motor 142 is operating, e.g., the minimum torque value is the torque value of operating motor 142 without processing food contents. In particular, controller 120 may be configured to compare received measurements of the operating parameter of motor 142 with the baseline torque value and use the comparison to determine a state of the mixing process. For example, determining the state of the stand mixer may include determining that the measured torque value is equal to the baseline torque value. As such, controller 120 of stand mixer 100 may measure torque to detect when the torque is low to automatically reverse and/or forward the direction of disk 230 in order to process the food items in food mill bowl 220, or to automatically stop motor 142.

As may be seen from the above, a stand mixer appliance may include a food mill attachment, which may include a bowl with a grate at the bottom, and a shaft attached to a blade. The food mill bowl assembly may be placed in the stand mixer bowl, which may couple to lift arms of the stand mixer. The rotating shaft of the food mill may be connected to an orbital of the stand mixer using an orbital adapter and other interlocking parts. The food mill may operate in both directions, around an axis, to scrape down the grater for food processing. The stand mixer may automatically sense torque to detect when the torque is low to reverse/forward to process the food items in the mill or to automatically stop.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer defining a vertical direction, a lateral direction, and a transverse direction, the vertical, lateral, and transverse directions being mutually perpendicular, the stand mixer comprising:
a housing;
a motor disposed in the housing;
a controller in operable communication with the motor;
a mixing shaft operably coupled to the motor;
a mixing bowl positioned beneath the mixing shaft; and
a food mill attachment coupled to the bowl, the food mill attachment mechanically coupled to the mixing shaft, the food mill attachment comprising:
a transmission mechanically coupling a disk to the motor along a central axis, the disk rotatable around the central axis in both a clockwise direction and a counterclockwise direction;
a food mill bowl coupled to the mixing bowl, the disk positioned and rotatable within the food mill bowl, the food mill bowl configured to receive food items for processing, the food mill bowl defining a plurality of apertures through a bottom side of the food mill bowl.

2. The stand mixer of claim 1, wherein the stand mixer comprises an orbital coupled to the housing at the mixing shaft, and the transmission of the food mill attachment comprises an orbital adapter configured to removably couple to the orbital.

3. The stand mixer of claim 2, wherein the orbital adapter comprises a biasing member configured to secure the coupling of the orbital adapter to the orbital.

4. The stand mixer of claim 2, wherein the orbital adapter comprises a central shaft extending downward along the central axis of the stand mixer.

5. The stand mixer of claim 4, wherein the transmission comprises a transfer block and a receiver block, the transfer block coupled to the central shaft of the orbital adapter, the receiver block coupled to a shaft extending from the disk, the transfer block configured to transfer torque from the central shaft to the receiver block, thereby rotating the disk.

6. The stand mixer of claim 1, wherein the bottom side of the food mill bowl comprises a conical shape at an angle commensurate to the disk.

7. The stand mixer of claim 1, wherein the food mill bowl comprises a scrape plate positioned proximate a top side of the disk, the scrape plate configured to scrape food items from the top side of the disk when the disk is rotated in one of the directions around the central axis.

8. A stand mixer, comprising:
a housing;
a motor disposed in the housing;
a mixing shaft operably coupled to the motor;
a mixing bowl positioned beneath the mixing shaft; and
a food mill attachment coupled to the bowl, the food mill attachment mechanically coupled to the mixing shaft, the food mill attachment comprising:
a transmission mechanically coupling a disk to the motor along a central axis, the disk rotatable around the central axis in both a clockwise direction and a counterclockwise direction;
a food mill bowl coupled to the mixing bowl, the food mill bowl configured to receive food items for processing.

9. The stand mixer of claim 8, wherein the stand mixer comprises an orbital coupled to the housing at the mixing shaft, and the transmission of the food mill attachment comprises an orbital adapter configured to removably couple to the orbital.

10. The stand mixer of claim 9, wherein the orbital adapter comprises a biasing member configured to secure the coupling of the orbital adapter to the orbital.

11. The stand mixer of claim 9, wherein the orbital adapter comprises a central shaft extending downward along the central axis of the stand mixer.

12. The stand mixer of claim 11, wherein the transmission comprises a transfer block and a receiver block, the transfer block coupled to the central shaft of the orbital adapter, the receiver block coupled to a shaft extending from the disk, the transfer block configured to transfer torque from the central shaft to the receiver block, thereby rotating the disk.

13. The stand mixer of claim 8, wherein the food mill bowl defines a plurality of apertures through a bottom side of the food mill bowl, and the bottom side of the food mill bowl comprises a conical shape at an angle commensurate to the disk.

14. The stand mixer of claim 8, wherein the food mill bowl comprises a scrape plate positioned proximate a top side of the disk, the scrape plate configured to scrape food items from the top side of the disk when the disk is rotated in one of the directions around the central axis.

15. A food mill attachment for a stand mixer, comprising:
a transmission mechanically coupling a disk to the stand mixer, the disk rotatable around a central axis in both a clockwise direction and a counterclockwise direction; and
a food mill bowl configured for receipt of food items for processing, the food mill bowl defining a plurality of apertures through a bottom side of the food mill bowl,
wherein the disk is positioned within the food mill bowl and is rotatable within the food mill bowl.

16. The food mill attachment of claim 15, wherein the transmission of the food mill attachment comprises an orbital adapter configured to removably couple to the stand mixer.

17. The food mill attachment of claim 16, wherein the orbital adapter comprises a central shaft extending downward along the central axis of the stand mixer.

18. The food mill attachment of claim 17, wherein the transmission comprises a transfer block and a receiver block, the transfer block coupled to the central shaft of the orbital adapter, the receiver block coupled to a shaft extending from the disk, the transfer block configured to transfer torque from the central shaft to the receiver block, thereby rotating the disk.

19. The food mill attachment of claim 15, wherein the bottom side of the food mill bowl comprises a conical shape at an angle commensurate to the disk.

20. The food mill attachment of claim 15, wherein the food mill bowl comprises a scrape plate positioned proximate a top side of the disk, the scrape plate configured to scrape food items from the top side of the disk when disk is rotated in one of the directions around the central axis.
